(19) United States
(12) Patent Application Publication
(10) Pub. No.: US 2021/0053117 A1
(43) Pub. Date: Feb. 25, 2021

(54) METHOD FOR PREPARING FERRITE/REDUCING METAL COMPOSITE PARTICLES AND METHOD FOR PREPARING HIGH TEMPERATURE RESISTANT STEALTH COATING BASED ON 3D LASER PRINTING

(71) Applicant: Harbin Institute of Technology, Heilongjiang (CN)

(72) Inventors: Jiantang Jiang, Heilongjiang (CN); Zhenjie Guan, Heilongjiang (CN); Yong Yang, Heilongjiang (CN); Liang Zhen, Heilongjiang (CN); Wenzhu Shao, Heilongjiang (CN)

(73) Assignee: Harbin Insttitute of Technology, Heilongjiang (CN)

(21) Appl. No.: 16/940,763

(22) Filed: Jul. 28, 2020

(30) Foreign Application Priority Data
Aug. 21, 2019 (CN) 201910773810.3

(51) Int. Cl. B22F 3/10; B33Y 10/00; B33Y 40/10; B22F 9/20; B22F 9/02; B22F 1/00; B22F 3/105

(52) U.S. Cl. CPC B22F 3/1039; B33Y 10/00; B33Y 40/10; B22F 9/20; B22F 2304/10; B22F 1/0014; B22F 1/0048; B22F 3/1055; B22F 2301/35; B22F 9/026

(57) ABSTRACT

The present invention relates to a method for preparing ferrite/reducing metal composite particles and a method for preparing a high temperature resistant stealth coating based on 3D laser printing, belonging to the technical field of preparation of absorbing coatings. The present invention aims to solve the problems that an existing high-temperature absorbing coating has insufficient coating/matrix bonding force, the microstructure of the coating is difficult to control, and electromagnetic properties cannot be ensured. In the present invention, nano ferrite powder and nano reducing metal powder are prepared into composite particles by a mixing granulation process. In a sealed preparation chamber of a 3D printing device, composite particles are subjected to laser-induced in-situ reaction on the surface of a substrate to prepare a high temperature resistant stealth coating. The present invention is applied to high temperature resistance and stealth of components and prevention and control of electromagnetic pollution.

### TECHNICAL FIELD

The present invention belongs to the technical field of preparation of absorbing coatings, and particularly relates to a method for preparing ferrite/reducing metal composite particles and a method for preparing a high temperature resistant stealth coating based on 3D laser printing, which can be applied to high temperature resistance and stealth of components and prevention and control of electromagnetic pollution.

### BACKGROUND

In the field of national defense, there is an increasing for radar stealth of high-temperature components such as engines. In the field of civil technology, with the explosive growth of power level and application scale of a radar technology and a wireless communication technology, the problems of electromagnetic leakage and electromagnetic pollution caused by stray electromagnetic waves are increasingly prominent. The application of an absorbing coating on a component can effectively absorb stray electromagnetic waves and is an effective means to solve the problems of electromagnetic leakage and electromagnetic pollution. The conventional electromagnetic wave absorbing coating is mostly prepared in a coating mode by using a resin matrix and adding an absorbent. The coating easily peels off from the matrix when the ambient temperature is higher than 150° C., which cannot meet the functional requirements for stray electromagnetic wave absorption or wave absorption stealth of high-temperature components of communication equipment and national defense equipment. Therefore, the high temperature resistant absorbing coating becomes a key foundation for electromagnetic radiation control in a high temperature environment, and corresponding technologies need to be developed urgently.

At present, there are few researches on high-temperature absorbing coatings. Preliminary progress has been made in the preparation of resin-based absorbing coatings by using high temperature resistant resins or the preparation of ceramic-based absorbing coatings by using thermal spraying methods, but problems such as complex process and insufficient coating/matrix bonding force are common. Moreover, it is difficult to control the microstructures of the coatings prepared by the two methods, and their electromagnetic properties cannot be ensured, making it difficult to meet the application requirements.

### SUMMARY

In view of the problems that an existing high-temperature absorbing coating/matrix has insufficient bonding force and it is difficult to control a microstructure and electromagnetic properties cannot be ensured, the present invention provides a method for preparing a high temperature resistant stealth coating based on 3D laser printing technology. In the present invention, a ferromagnetic/dielectric composite coating is obtained by laser-induced in-situ thermite reaction based on the 3D laser printing technology. The present invention has the advantages of simple process, compact and complete coating, and tissue performance meeting the requirement for high temperature resistance and stealth, is an innovation in the technical field of preparation of high temperature resistant stealth coatings, and has obvious advantages and wide application prospect.

In the present invention, the high temperature resistance and the electromagnetic absorption performance are organically fused, and the coating is prepared in an in-situ synthesis manner, so that the service requirements for high temperature resistance and stealth of the coating are met, and the problem of insufficient film layer/matrix bonding force is solved at the same time.

The present invention provides a method for preparing ferrite/reducing metal composite particles, and the ferrite/reducing metal composite particles are prepared by a mixing granulation process. The method specifically includes the following steps:

step 1: uniformly mixing nano ferrite powder, nano reducing metal powder and an additive to obtain slurry; and

step 2: performing granulation by centrifugal spray drying, performing stage treatment after the granulation is completed, and selecting particles with a spherical shape and a size of 10-60 μm to obtain ferrite/reducing metal composite particles;

where the additive in step 1 is polyvinyl alcohol (PVA) or carboxymethyl cellulose (CMC).

Further, in step 1, the ferrite powder may be one of Fe₃O₄, BaFe₁₂O₁₉ and CoFe₂O₄; and the ferrite powder may be spherical with a diameter of 50-500 nm.

Further, the reducing metal powder in step 1 may be Al powder, Zn powder or Zr powder; and the reducing metal powder may be spherical with a diameter of 50-500 nm.

Further, in step 1, the weight ratio of the ferrite powder to the reducing metal powder may be (1-5):1.

Further, in step 1, the usage of the additive may be 0.1%-3% of the total weight of the ferrite powder and the reducing metal powder.

Further, process parameters for the granulation in step 2 are as follows: an inlet temperature of a spray drying tower is 220-260° C., an outlet temperature of the spray drying tower is 100-120° C., and a rotating speed of an atomizing disc in the spray drying tower is 18000-30000 r/min.

In the present invention, a method for preparing a high temperature resistant stealth coating based on 3D laser printing includes the following steps:

step 1: sandblasting the surface of a substrate before coating preparation to remove oxide films and pollutants;

step 2: placing the substrate sandblasted in step 1 in a preparation chamber, and cleaning the preparation chamber with argon 3-5 times; loading ferrite/reducing metal composite particles prepared by the foregoing method into a powder feeder; and

step 3: after setting the process parameters, starting a program to perform 3D printing, where in the printing process, the powder feeder synchronously sends powder to a light beam scanning position to perform induced reaction (that is, once the powder is sent to the surface of the substrate, the powder is ignited by laser to react, and reaction products are uniformly deposited on the surface of the substrate and rapidly perform metallurgical bonding); after the 3D printing of the set area is finished, shutting down the laser and a powder feeding mechanism, and taking out the substrate after the substrate is cooled, to obtain the high temperature resistant stealth coating on the surface of the substrate.

Further, the material of the substrate in step 1 may be a titanium alloy plate or a steel plate.

Further, the substrate in step 1 may have a thickness of 4-10 mm.

Further, the 3D printing process parameters in step 3 are as follows: a powder feeding amount is 1-5 rap/min, an optical fiber laser is adopted, the laser power is set to 400-1000 W, a laser spot diameter is 1-3 mm, an overlap rate of adjacent passes of printing is 20%-30%, and a laser scanning speed is 600-1200 mm/min; and a moving speed of the powder feeder is consistent with the scanning speed of the laser.

Further, in the printing process in step 3, the thickness of the coating may be adjusted and controlled by adjusting the powder feeding amount and the scanning speed, and the thickness of the coating obtained by printing each pass may be 100-1200 μm.

According to the present invention, mixed powder of Fe₃O₄/Al and BaFe₁₂O₁₉/Al and the like is induced by laser irradiation to undergo thermite reaction to form a composite structure in which Fe particles are embedded in an Al₂O₃ matrix; Al₂O₃ and other oxides are taken as heat-resistant components to ensure the temperature resistance of a coating system, and Fe particles are taken as an absorbent to realize electromagnetic wave absorption and losses. The present invention realizes the control of coating microstructure and microwave electromagnetic performance through the adjustment of raw material powder and process parameters.

The present invention realizes the in-situ reaction and preparation of the high-temperature absorbing coating, where the absorbent (Fe particles) and the matrix (oxides such as Al₂O₃) coexist and fuse well in situ.

In the present invention, the coating is synthesized in situ through laser-induced thermit reaction, and the microstructural characteristics of the coating can be finely controlled through adjustment of parameters such as laser power, scanning speed and powder feeding amount.

The matrix of the coating synthesized in situ by laser-induced thermit reaction in the present invention mainly includes Al₂O₃ and an electromagnetic loss component is Fe particles embedded in the Al₂O₃ matrix. The coating/substrate has good bonding properties, and the coating has high temperature resistance/weather resistance and can still normally serve in a high-temperature environment.

The present invention provides a new idea for the development and application of the high temperature resistant stealth coating, meets the comprehensive requirements for in-situ manufacturing, firm bonding and high temperature resistance and stealth of surface coatings of high-temperature components of modern equipment, is expected to be applied to high-temperature components of military/civil equipment, and solves the problem in the field of high temperature resistance and stealth.

The present invention integrates the advantages of thermite reaction, 3D printing and other technologies, realizes integrated manufacturing of digital-analog driving stealth materials/coatings, provides a novel tool for coating development in the stealth technology field, is expected to form a first-mover advantage, and drives the functional expansion and technological increment of the 3D printing technology.

### BRIEF DESCRIPTION OF THE DRAWINGS

FIG. 1 shows the morphology (an SEM image) of Fe₃O₄/Al composite particles;

FIG. 2 shows the surface morphology of an Fe/Al₂O₃ laser-induced in-situ reaction coating;

FIG. 3 shows a phase composition and microstructure of an Fe/Al₂O₃ laser-induced in-situ reaction coating;

FIG. 4 shows the microstructure of an Fe/Al₂O₃ laser-induced in-situ reaction coating, where FIG. 4(a) shows a coating surface microstructure, and FIG. 4(b) shows a coating cross-section;

FIG. 5 shows electromagnetic wave absorption properties of an Fe/Al₂O₃ laser-induced in-situ reaction coating; and

FIG. 6 is a typical wave absorbing curve of reflection loss characteristics of a coating measured by a free space approach in Example 2.

### DETAILED DESCRIPTION

Example 1: A method for preparing ferrite/reducing metal composite particles used in this example is implemented by a mixing granulation process. The method specifically includes the following steps:

Step 1: Uniformly mix spherical Fe₃O₄ particles with a diameter of 80 nm, spherical Al particles with a diameter of 50 nm and a PVA additive to obtain slurry, where the weight ratio of Fe₃O₄ to Al is 3.2:1 and a usage of the additive is 0.5% of the total weight of ferrite powder and reducing metal powder.

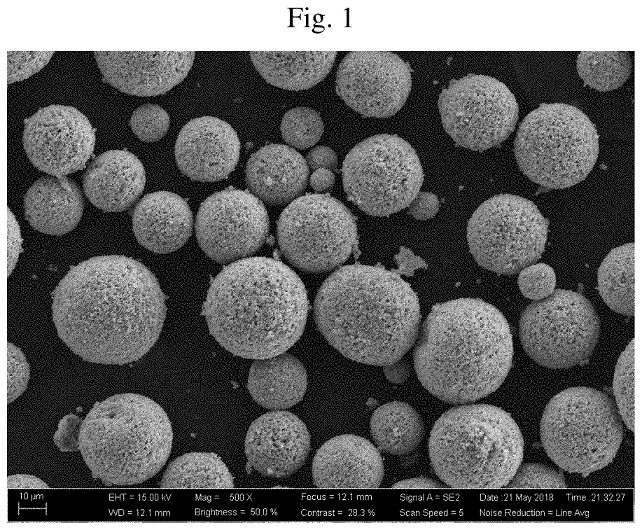

Step 2: Granulate the obtained slurry by centrifugal spray drying, where spray drying process parameters are as follows: an inlet temperature of a spray drying tower is 220° C., an outlet temperature of the spray drying tower is 100° C., and a rotating speed of an atomizing disc in the spray drying tower is 20000 r/min; after the granulation is completed, perform stage treatment, where the particles each have a spherical shape and an average size of 50 μm, with the typical morphology of the particles shown in FIG. 1, thus obtaining Fe₃O₄/Al composite particles.

In this example, a method for preparing a high temperature resistant stealth coating based on 3D laser printing includes the following steps:

Step 1: Use a titanium alloy plate with a thickness of 5 mm as a substrate, and sandblast the surface of the substrate to remove oil stains and oxide films.

Step 2: Place the titanium alloy substrate into a preparation chamber, and repeatedly inflate and deflate the preparation chamber with argon to clean the preparation chamber 3 times; and load Fe₃O₄/Al composite particles prepared by the foregoing method into a powder feeder.

Step 3: After setting the process parameters, starting a program to perform 3D printing, where in the printing process, the powder feeder synchronously sends powder to a light beam irradiation position on the substrate to perform laser-induced reaction (that is, once the powder is sent to the surface of the substrate, the powder is ignited by laser to react, and reaction products are uniformly deposited on the surface of the substrate and rapidly perform metallurgical bonding); after the 3D printing of the set area is finished, shut down the laser and a powder feeding mechanism, and take out the substrate after the substrate is cooled, to obtain the high temperature resistant stealth coating on the surface of the substrate.

The 3D printing process parameters set in this example were as follows: an optical fiber laser was adopted, the laser power was set to 700 W, a laser spot diameter was 3 mm, an overlap rate of adjacent passes of printing was 30%, and a laser scanning speed was 600 mm/min; a powder feeding amount was 2 rap/min, and a moving speed of the powder feeder was consistent with the scanning speed of the laser; and the coating had a thickness of 700 μm.

In this example, in-situ thermit reaction was performed under the induction by laser. When Fe₃O₄/Al composite particles were used in the laser-induced reaction process, refined thermite reaction sites in the particles enabled the generated Fe and Al₂O₃ to have fine micro-composite structures: fine Fe particles were uniformly dispersed in a matrix composed of Al₂O₃; and the coating obtained in this example had obvious electromagnetic absorption properties.

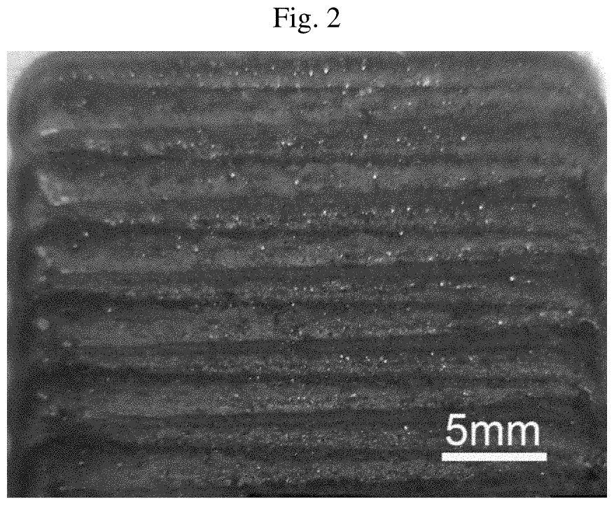

In this example, as soon as the laser was started in the coating preparation process, the composite powder at the irradiation position was ignited, accompanied by bright flame and smoke, indicating that the thermite reaction was very strong. According to a preset scanning path, the whole coating was finally formed by gradual scanning. The surface morphology of the coating formed by the reaction is shown in FIG. 2. The coating formed by each pass of scanning can be clearly distinguished from the figure. As can be seen from the figure, the coating prepared by this process had a complete structure and compact surface.

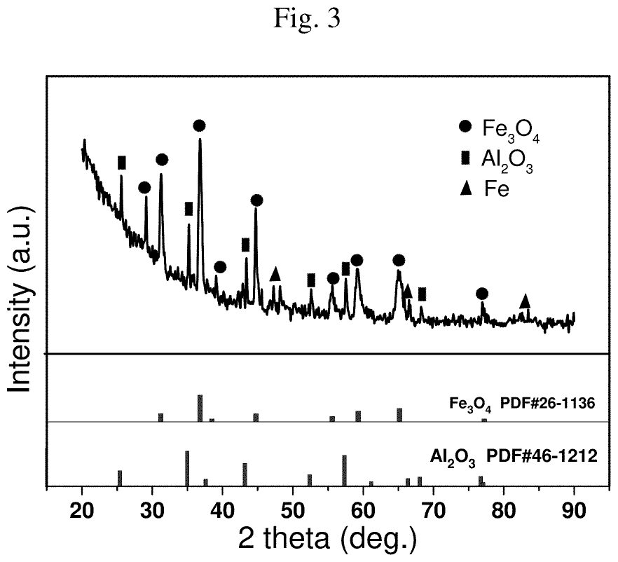

XRD analysis shows that the phase composition of the coating after reaction is Fe, Al₂O₃ and Fe₃O₄ that was not reacted completely, as shown in the left figure in FIG. 3.

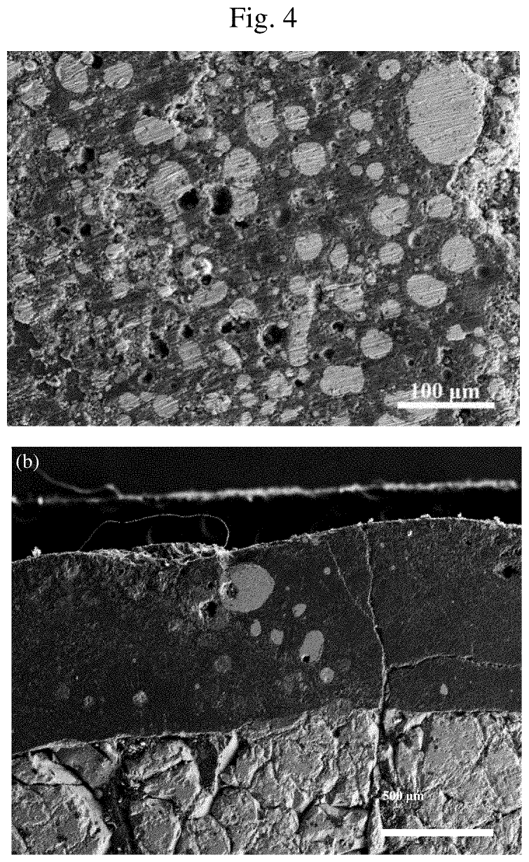

The typical characteristics of the microstructure of the coating surface are shown in FIG. 4(a). It can be seen from the figure that Fe particles were uniformly dispersed on the Al₂O₃/Fe₃O₄ ceramic matrix; and there were a certain number of pores in the matrix. Statistics show that the Fe particles had a size of 5-80 μm, and mostly had a size about 50 μm. An SEM image of the cross-section of the coating is shown in FIG. 4(b). The observation shows that the coating was complete and compact and bonded well with the matrix, and the coating had a thickness of about 700 μm.

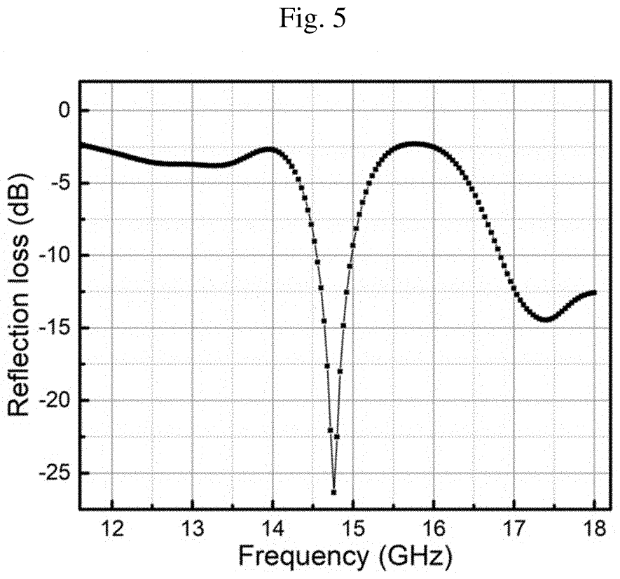

The reflection loss characteristics of the coating were tested by using a 200 mm×200 mm test plate and a free space approach. A typical reflection loss curve is shown in FIG. 5. As can be seen from the figure, the maximum absorption of the coating at 15.3 GHz was greater than 25 dB. The coating was subjected to a high-temperature test. The coating was placed in a 600° C. muffle furnace for treatment for 30 minutes, then taken out and directly put into cold water, so that the coating did not peel off and still maintained a compact and complete structure. Moreover, the weight of each sample hardly changed before and after high temperature treatment, as shown in Table 1, indicating that the coating had outstanding oxidation resistance.

TABLE 1
Weight changes of Fe/Al₂O₃ laser-induced in-situ reaction coatings
before and after heat preservation at 600° C. for 30 min

| | Weight (g) before | Weight (g) after | |
|---|---|---|---|
| | high temperature | high temperature | Weight |
| Sample No. | treatment | treatment | difference (g) |
| 1 | 15.709 | 15.711 | 0.002 |
| 2 | 16.854 | 16.852 | −0.002 |
| 3 | 15.804 | 15.788 | −0.016 |
| 4 | 15.972 | 15.964 | −0.008 |
| 5 | 17.710 | 17.701 | −0.009 |

The core of this example is thermit reaction, and its specific reaction formula is:

Fe₃O₄ (powder)+Al (powder)→Al₂O₃ (coating matrix)+Fe (wave absorbing particles)

Example 2: In this example, a method for preparing a high temperature resistant stealth coating based on 3D laser printing includes the following steps:

A method for preparing ferrite/reducing metal composite particles used in this example is implemented by a mixing granulation process. The method specifically includes the following steps:

Step 1: Uniformly mix spherical BaFe₁₂O₁₉ particles with a diameter of 100 nm, spherical Al particles with a diameter of 50 nm and an additive (CMC) to obtain slurry, where the weight ratio of the BaFe₁₂O₁₉ particles to the Al particles is 3.2:1, and a usage of the additive is 1% of the total weight of ferrite powder and reducing metal powder.

Step 2: Granulate the obtained slurry by centrifugal spray drying, where spray drying process parameters are as follows: an inlet temperature of a spray drying tower is 260° C., an outlet temperature of the spray drying tower is 120° C., and a rotating speed of an atomizing disc in the spray drying tower is 20000 r/min; after the granulation is completed, perform stage treatment to obtain spherical BaFe₁₂O₁₉/Al composite particles with an average size of 30 μm.

In this example, a method for preparing a high temperature resistant stealth coating based on 3D laser printing includes the following steps:

Step 1: Use a steel plate with a thickness of 8 mm as a substrate, and sandblast the surface of the substrate to remove oil stains and oxide films.

Step 2: Place the substrate into a preparation chamber, and clean the preparation chamber 3 times; and load BaFe₁₂O₁₉/Al composite particles prepared by the foregoing method into a powder feeder.

Step 3: After setting the process parameters, starting a program to perform 3D printing, where in the printing process, the powder feeder synchronously sends powder to a light beam irradiation position on the substrate to perform laser-induced reaction (that is, once the powder is sent to the surface of the substrate, the powder is ignited by laser to react, and reaction products are uniformly deposited on the surface of the substrate and rapidly perform metallurgical bonding); after the 3D printing of the set area is finished, shut down the laser and a powder feeding mechanism, and take out the substrate after the substrate is cooled, to obtain the high temperature resistant stealth coating on the surface of the substrate.

The 3D printing process parameters in this example were as follows: an optical fiber laser was adopted, the laser power was set to 1000 W, a laser spot diameter was 2 mm, an overlap rate of adjacent passes of printing was 20%, and a laser scanning speed was 800 mm/min; a powder feeding amount was 4 rap/min, and a moving speed of the powder feeder was consistent with the scanning speed of the laser. The coating had a thickness of 700 μm.

The core of this example is thermit reaction, and its specific reaction formula is:

BaFe₁₂O₁₉ (powder)+Al (powder)→Al₂O₃(coating matrix)+Fe (wave absorbing particles)

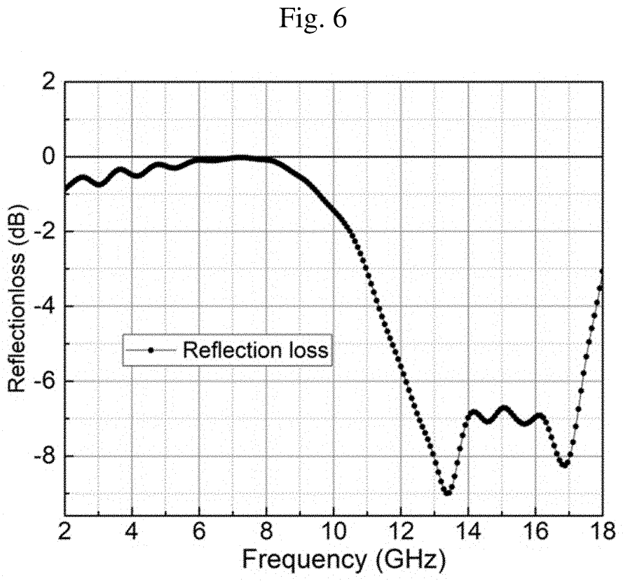

The reflection loss characteristics of the coating were tested by using a free space approach. A typical wave absorbing curve is shown in FIG. 6. As can be seen from the figure, the absorption of the coating in the 11.8-17.6 GHz band was greater than 5 dB.

1. A method for preparing ferrite/reducing metal composite particles, wherein the ferrite/reducing metal composite particles are prepared by a mixing granulation process, comprising:
(a) uniformly mixing nano ferrite powder, nano reducing metal powder and an additive to obtain slurry; and
(b) performing granulation by centrifugal spray drying, performing stage treatment after the granulation is completed, and selecting particles with a spherical shape and a size of 10-60 μm to obtain ferrite/reducing metal composite particles;
wherein the additive in step (a) is polyvinyl alcohol (PVA) or carboxymethyl cellulose (CMC).

2. The method for preparing ferrite/reducing metal composite particles according to claim 1, wherein in step (a), the ferrite particles are one of Fe₃O₄, BaFe₁₂O₁₉ and CoFe₂O₄; and the ferrite powder is spherical with a diameter of 50-500 nm.

3. The method for preparing ferrite/reducing metal composite particles according to claim 1, wherein the reducing metal particles in step (a) 4 are Al particles, Zn particles or Zr particles; and the reducing metal powder is spherical with a diameter of 50-500 nm.

4. The method for preparing ferrite/reducing metal composite particles according to claim 1, wherein in step (a), the weight ratio of the ferrite powder to the reducing metal powder is (1-5):1; and the usage of the additive is 0.1%-3% of the total weight of the ferrite powder and the reducing metal powder.

5. The method for preparing ferrite/reducing metal composite particles according to claim 1, wherein process parameters for the granulation in step (b) are an inlet temperature of a spray drying tower is 220-260° C., an outlet temperature of the spray drying tower is 100-120° C., and a rotating speed of an atomizing disc in the spray drying tower is 18000-30000 r/min.

6. A method for preparing a high temperature resistant stealth coating based on 3D laser printing, comprising:
(a) sandblasting the surface of a substrate to remove oxide films and pollutants;
(b) placing the substrate treated in step (a) on a worktable in a preparation chamber, and cleaning the preparation chamber with argon 3-5 times; loading ferrite/reducing metal composite particles prepared by the method of claim 1 into a powder feeder; and
(c) after setting the process parameters, starting a program to perform 3D printing, wherein in the printing process, the powder feeder synchronously sends powder to a laser irradiation area to perform laser-induced reaction and preparation; after the 3D printing of the set area is finished, shutting down the laser and a powder feeding mechanism, and taking out the substrate after the substrate is cooled, to obtain the high temperature resistant stealth coating on the surface of the substrate.

7. A method for preparing a high temperature resistant stealth coating based on 3D laser printing, comprising:
(a) sandblasting the surface of a substrate to remove oxide films and pollutants;
(b) placing the substrate treated in step (a) on a worktable in a preparation chamber, and cleaning the preparation chamber with argon 3-5 times; loading ferrite/reducing metal composite particles prepared by the method of claim 2 into a powder feeder; and
(c) after setting the process parameters, starting a program to perform 3D printing, wherein in the printing process, the powder feeder synchronously sends powder to a laser irradiation area to perform laser-induced reaction and preparation; after the 3D printing of the set area is finished, shutting down the laser and a powder feeding mechanism, and taking out the substrate after the substrate is cooled, to obtain the high temperature resistant stealth coating on the surface of the substrate.

8. A method for preparing a high temperature resistant stealth coating based on 3D laser printing, comprising:
(a) sandblasting the surface of a substrate to remove oxide films and pollutants;
(b) placing the substrate treated in step (a) on a worktable in a preparation chamber, and cleaning the preparation chamber with argon 3-5 times; loading ferrite/reducing metal composite particles prepared by the method of claim 3 into a powder feeder; and
(c) after setting the process parameters, starting a program to perform 3D printing, wherein in the printing process, the powder feeder synchronously sends powder to a laser irradiation area to perform laser-induced reaction and preparation; after the 3D printing of the set area is finished, shutting down the laser and a powder feeding mechanism, and taking out the substrate after the substrate is cooled, to obtain the high temperature resistant stealth coating on the surface of the substrate.

9. A method for preparing a high temperature resistant stealth coating based on 3D laser printing, comprising:
(a) sandblasting the surface of a substrate to remove oxide films and pollutants;
(b) placing the substrate treated in step (a) on a worktable in a preparation chamber, and cleaning the preparation chamber with argon 3-5 times; loading ferrite/reducing metal composite particles prepared by the method of claim 4 into a powder feeder; and
(c) after setting the process parameters, starting a program to perform 3D printing, wherein in the printing process, the powder feeder synchronously sends powder to a laser irradiation area to perform laser-induced reaction and preparation; after the 3D printing of the set area is finished, shutting down the laser and a powder feeding mechanism, and taking out the substrate after the substrate is cooled, to obtain the high temperature resistant stealth coating on the surface of the substrate.

10. A method for preparing a high temperature resistant stealth coating based on 3D laser printing, comprising:
(a) sandblasting the surface of a substrate to remove oxide films and pollutants;
(b) placing the substrate treated in step (a) on a worktable in a preparation chamber, and cleaning the preparation chamber with argon 3-5 times; loading ferrite/reducing metal composite particles prepared by the method of claim 5 into a powder feeder; and
(c) after setting the process parameters, starting a program to perform 3D printing, wherein in the printing process, the powder feeder synchronously sends powder to a laser irradiation area to perform laser-induced reaction and preparation; after the 3D printing of the set area is finished, shutting down the laser and a powder feeding mechanism, and taking out the substrate after the substrate is cooled, to obtain the high temperature resistant stealth coating on the surface of the substrate.

11. The method for preparing a high temperature resistant stealth coating based on 3D laser printing according to claim 6, wherein the material of the substrate in step (a) is a titanium alloy plate or a steel plate.

12. The method for preparing a high temperature resistant stealth coating based on 3D laser printing according to claim 7, wherein the material of the substrate in step (a) is a titanium alloy plate or a steel plate.

13. The method for preparing a high temperature resistant stealth coating based on 3D laser printing according to claim 8, wherein the material of the substrate in step (a) is a titanium alloy plate or a steel plate.

14. The method for preparing a high temperature resistant stealth coating based on 3D laser printing according to claim 9, wherein the material of the substrate in step (a) is a titanium alloy plate or a steel plate.

15. The method for preparing a high temperature resistant stealth coating based on 3D laser printing according to claim 10, wherein the material of the substrate in step (a) is a titanium alloy plate or a steel plate.

16. The method for preparing a high temperature resistant stealth coating based on 3D laser printing according to claim 6, wherein the substrate in step (a) has a thickness of 4-10 mm.

17. The method for preparing a high temperature resistant stealth coating based on 3D laser printing according to claim 7, wherein the substrate in step (a) has a thickness of 4-10 mm.

18. The method for preparing a high temperature resistant stealth coating based on 3D laser printing according to claim 8, wherein the substrate in step (a) has a thickness of 4-10 mm.

19. The method for preparing a high temperature resistant stealth coating based on 3D laser printing according to claim 6, wherein the 3D printing process parameters in step (c) are an optical fiber laser is adopted, the laser power is set to 400-1000 W, a laser spot diameter is 1-3 mm, an overlap rate of adjacent passes of printing is 20%-30%, a laser scanning speed is 600-1200 mm/min; a powder feeding amount is 1-5 rap/min, and a moving speed of the powder feeder is consistent with the scanning speed of the laser.

20. The method for preparing a high temperature resistant stealth coating based on 3D laser printing according to claim 6, wherein a thickness of the coating prepared by printing in each pass in the printing process in step (c) is 100-1200 μm.
